(19) United States
(12) Patent Application Publication
(10) Pub. No.: US 2015/0156214 A1
(43) Pub. Date: Jun. 4, 2015

(54) DETECTION AND PREVENTION OF ONLINE USER INTERFACE MANIPULATION VIA REMOTE CONTROL

(71) Applicant: White Ops, Inc., Brooklyn, NY (US)

(72) Inventor: Daniel KAMINSKY, San Francisco, CA (US)

(21) Appl. No.: 14/620,115

(22) Filed: Feb. 11, 2015

Related U.S. Application Data
(63) Continuation-in-part of application No. 14/057,730, filed on Oct. 18, 2013.
Application No. 14/057,730 is a continuation-in-part of application No. 14/093,964, filed on Dec. 2, 2013.
(60) Provisional application No. 61/938,306, filed on Feb. 11, 2014.

(51) Int. Cl. H04L 29/06; G06Q 30/02

(52) U.S. Cl. CPC H04L 63/1416; G06Q 30/0248

(57) ABSTRACT

A method for determining if a web browser is being operated by a local human or a remote agent, based on analysis of certain aspects of how the different users interact with a webpage. By employing various detection mechanisms, one is able to evaluate the user's actions in order to predict the type of user. The predictions are made by acquiring information on how the user loads, navigates, and interacts with the webpage and comparing that information with statistics taken from a control group. Performance metrics from all webpages containing similar elements are compiled by analysis servers and made available to the operator of a webpage through a variety of reporting mediums. By compiling such performance metrics, the method helps combat and prevent malicious automated traffic directed at advertisements and other aspects of a given webpage.

### CROSS-REFERENCE TO RELATED APPLICATIONS

This application is a Continuation-in-Part of U.S. patent application Ser. No. 14/057,730, filed Oct. 18, 2013 and also a Continuation-in-Part of U.S. patent application Ser. No. 14/093,964, filed Dec. 2, 2013, both incorporated herein by reference. This patent application also claims priority to, and incorporates fully by reference, U.S. Provisional Patent Application No. 61/938,306, filed Feb. 11, 2014.

### FIELD OF THE INVENTION

This invention relates to the general field of Internet communications software, and has certain specific applications in the analytical evaluation of Internet communications.

### BACKGROUND OF THE INVENTION

For a host of reasons, numerous individuals and organizations are actively engaged on a daily basis on sending malicious traffic to web pages and other internet destinations. A majority of such malicious traffic results from bots, automated code that masquerades as human traffic. A wide variety of bots exist that can fool individuals and companies into believing, for example, that their ads are being seen and clicked by humans. Companies and individuals pay other companies and individuals for the placement of advertisements on the internet where they may be seen and interacted with by people who may be interested in learning more about or purchasing their products. There are also classes of bots whose purpose is to scrape content from websites, steal the personal information from user profiles, and mimic human browsing behavior in order to appear human. The ability to disguise itself as a human is one of the ultimate goals of a bot, as this allows it to circumvent anti-fraud blacklists, get itself placed on anti-fraud whitelists, and fool companies who pay for demographic and personal information into believing that this information is valid.

There is, however, more than one mode in which a compromised machine may be leveraged. One mode is by a series of “batch” commands, issued to a “bot” resident on the infected machine. This “bot” will take these commands and perform functions like search for files, extort the user, or browse the web. Another mode of leveraging compromised access is referred to herein as “remote control” and defined hereinbelow. The present application describes methods and systems for detecting this second mode of leveraging. The technology of this particular application addresses methods for detection and prevention of online user interface manipulation via remote control and applications for those methods.

### SUMMARY OF THE INVENTION

A second overall type of online fraud, caused not by automated bots but by control of the same compromised host by a remote and human attacker, is increasingly causing concern with regard to the protection of online information. With remote control, a human is actually in control of the interface; it is not, however, the human who owns the machine, system, or network. In Remote Control, the criminal gains access at a distance by taking control of a user interface such as Skype, or by infecting the host computer via malware and then using it as a proxy for the attacker's computer. Methods of detecting remote control are unique and different from methods used for detecting bot activity. The following description provides an overview of methods to detect remote control as well as non-limiting examples of the methods described.

Data collection by the analysis server is made possible by code snippets inserted (or injected) into the page code by the web server before the page is sent to the user's browser. This code performs data collection about the user's interaction with the web page and transmits the collected data to the analysis server via multiple communication channels.

At the remote control detection stage, data transmitted to the analysis server is checked if it matches a pattern characteristic for true human interaction or remote control submission patterns. The typical elements of a bot pattern include, but are not limited to, (1) interaction with invisible elements of the page, (2) missing properties of an interaction (for example, a mouse click), (3) wrong interaction timing (for example, a mismatch between mouse down and mouse up timestamp), (4) interface behavior being atypical for human (for example, mouse moving along an absolutely straight line), (5) wrong page element property due to the fact that a bot failed to guess correctly what data will be entered by a browser during the page load, (6) a set of available communication channels does not match the set characteristic for the typical human-operated computer. The typical elements of a remote control pattern are similar to those for a bot pattern, with the addition of (7) graphical optimization variances, (8) update frequency variances, and (9) other interactive latencies. The results of the detection are provided to the customer of the analysis system in real time or, alternatively, as a report for a given time period.

### BRIEF DESCRIPTION OF THE DRAWINGS

FIG. 1 illustrates an example of the deployment of the present invention in a typical webpage scenario.

FIG. 2 illustrates an example of the process employed by the present invention to analyze internet traffic and determine whether a given user is a human or an automated agent.

FIG. 3 illustrates the general data collection process of the present invention.

FIG. 4 is a flowchart illustrating where the process of remote control detection stands as it relates to the overall process of fraud detection.

FIG. 5 is a flowchart illustrating a particular process of remote control detection as it relates to the collection of mouse events and graphical optimization detection.

### DETAILED DESCRIPTION OF THE PREFERRED EMBODIMENT

### Definitions

HTML (HyperText Markup Language). The primary programming language used for creating, transmitting and displaying web pages and other information that can be displayed in an Internet browser.

HTTP (Hypertext Transfer Protocol). The standard World Wide Web client-server protocol used for the exchange of information (such as HTML documents, and client requests for such documents) between a Web browser and a Web server. HTTP includes several different types of messages which can be sent from the client to the server to request different types of server actions. For example, a “GET” message, which has the format GET <URL>, causes the server to return the content object located at the specified URL.

Means for detecting. This term includes, but is not limited to, actively inserting a code snippet into a page HTML code before the page is sent to a browser or passive monitoring of otherwise normal behavior. Active insertions of code can be static, meaning that they contain fully the amount of material required to perform a complete analysis according to the present invention. Or active insertions can be dynamic, meaning that they communicate with the detection network to retrieve additional code or description keys, resulting in compilation of additional statistical data. While the below examples speak of active insertion, they should be read to include the possibility of passive monitoring as an alternate means for detection.

Code Snippet. Although the term “snippet” may imply a small portion, this term should not be read as limiting—the amount of code inserted can range in size. The code snippet is modularized, with chunks for elements including, but not limited to, browser DOM analysis, flash timing analysis, mouse event capture, etc. The ability to dynamically mutate a given code snippet allows for correlation of bot types and/or classes with customer financial flows, e.g., by integrating parameters (“analysis dimensions”) from a given customer into a given snippet.

Bot, remote control. Most malicious software is executed with the attacker physically distant from the machine being controlled. This forces the attacker into either (1) non-interactive bulk control or “interactive direct control.” Non-interactive bulk control, referred to herein as “bots,” is defined as a series of commands, distributed by a “command and control” node. Interactive direct control, herein referred to as “remote control,” is defined as control by a real human, albeit attacker, from a location other than the location of the compromised machine, wherein the attacker may access additional information via networks open through the compromised machine (e.g., intranet or internee). Remote control takes two primary forms, both of which are detected by using the methods described herein. In one form of remote control, the user interface—windows, mouse, keyboard—are rigged up for remote driving. In the other form, the network connectivity of the host is hijacked and all software running on the attacker's machine looks like it's coming from the compromised host.

The disclosure of U.S. patent application Ser. No. 14/057,730 is incorporated herein in its entirety. The present invention further develops the technology disclosed in U.S. patent application Ser. No. 14/057,730, disclosing a method to detect whether a computer is being controlled remotely by a human other than the actual owner or actual user of that computer (remote control detection).

The detection of a non-local user (either via batch automation or remote control) is a uniquely strong signal of fraud, since the vast majority of legitimate use involves local users, and the vast majority of illegitimate use does not involve local use. Legitimate users are represented online by their computers and the “personal entropy” (i.e., “cookies” device configuration) that infuses their particular systems; attackers who have been detected in the past for lacking this entropy may recover it by simply running their attacks from user computers, controlling them remotely (remote control). This type of remote control is discussed and prevented by application of the present disclosure.

The present invention further comprises a method to detect each of the current remote control methods used by an attacker.

The present invention further comprises a method to detect whether the host machine has been infected or infiltrated by an attacker, and also whether the host machine is being used as a proxy. Proxy detection occurs, for example, by comparison of OS level acknowledgements vs. application layer responses. For example, a client may request http://site.com/foo and receive an immediate HTTP 302 Redirect to http://site.com/bar. It will immediately follow the redirect to acquire the content for http://site.com/bar. If the connection is proxied for a client application that is in fact several thousand miles away, the operating system of the local user will acknowledge receiving the HTTP 302 long before the client application of the remote attacker sees the request to issue a second HTTP query for http://site.com/bar. With reference to a timeline, the process can she be shown as follows (the difference is the timing of the final step):

LOCAL (T=time in seconds):
T=0: Client Application requests http://site.com/foo.
T=1: Server responds with HTTP 302 Redirect, saying to satisfy this request retrieve instead http://site.com/bar.
T=2: Client Operating System (OS) acknowledges HTTP 302 Redirect.

T=2.01 Client Application requests http://site.com/bar.

REMOTE (T=time in seconds):
T=0: Client Application requests http://site.com/foo.
T=1: Server responds with HTTP 302 Redirect, saying to satisfy this request retrieve instead http://site.com/bar.
T=2: Client OS acknowledges HTTP 302 Redirect.
T=3: Client Application requests http://site.com/bar.

It is noted that, in the local case, the packets for the client OS acknowledgement and the packets for the client application second request may be coalesced into the same packet. Such coalescing is not possible when the OS and the Application are on different computers, with the OS merely running a proxy.

It is also noted that there are multiple ways of implementing this type of detection, from monitoring user space traffic to asking the operating system on the server to report its own internal metrics for data referred to as TCP RTT (Transmission Control Protocol Round Trip Time). Furthermore, proxy detection may be deployed passively against any protocol that has a high speed response to server traffic (e.g., HTTP redirects, or certain phases of TLS encrypted communication—this property can still be monitored though an encrypted channel), or active special probes may be deployed via JavaScript. Proxy detection can thus also be reported on (proxy detection report) and released by the system of the present invention.

The present invention further comprises methods for noting the difference between TCP acknowledgement and application acknowledgement, the difference being a reliable measure of the true triangulatable location of the remote controlling endpoint.

The present invention further comprises a method of detecting whether either the user interface (windows, mouse, keyboard) are rigged up for remote driving, or whether the network connectivity of the host is hijacked and all software running on an attacker's machine looks like it is coming from the compromised host.

For the case of interactive remote control, the update frequency and usage patterns of the keyboard and mouse vary in time and space. Mouse movements are regularized and possibly quantized to very specific forms. These forms are obvious even through encrypted tunnels, since encryption generally does not affect either the size of packets nor their frequency in time. This information also readily leaks through web page interfaces; Javascript events will fire at rates ultimately controlled by interactions between the network and the remote control driver. Profoundly regular patterns of interactive remote control are detectable in VNC, RDP, and even Virtual Desktop Traffic. Such regular patterns include but are not limited to (1) quantization of time (i.e., events are flushed from a queue every ‘n’ milliseconds), (2) coalescing of events (e.g., the mouse travels from point A to point B without motion in between points), (3) impact on CPU and network bandwidth of graphical screen updates (which must be compressed and transmitted, for remote control), and (4) reconfiguration of graphical hardware to minimize graphical screen updates (e.g., disabling of font smoothing and effects on drawing to a blank canvas using OS API's like Win32 GDI).

There is also the case of network remote control (the characteristic patterns are similar to and include those listed above for interactive remote control). It is noted that TCP is designed for end-to-end semantics, i.e., the client and the server are meant to be directly connected, and midpoints are merely supposed to be passing IP traffic that may or may not drop (more technical term?). In the case of a TCP proxy, this is not the case. A packet drop will be repaired in a midpoint, and end to end latencies will actually represent end-to-midpoint conditions. This is important because while proxies (often under the control of an attacker) are providing one degree of service, the actual applications remain end-to-end (not running on the proxy) and thus expose another degree of detection. Thus, two different latency profiles can be detected for the same connection. Many protocols have this type of end-to-end, “ping pong,” behaviors inherently, from HTTPS certificate acknowledgement to behavior in response to a HTTP 301. The present methods record the difference between TCP acknowledgement and application acknowledgement as a reliable measure of the true triangulatable location of the remote controlling endpoint.

Remote control involves transferring interactive control of the infected machine to a user not physically co-located with the machine. The interactive attacker may be using RDP or VNC technology, or alternatively a consumer platform like GoToMyPC or “PCAnywhere.” Since, most often, the most valuable thing a computer can be used for is to access resources on other computers, attackers will hop from an infected node to other nodes to which it has access (“lily padding”). It is difficult to detect lily padding because the seemingly right machine is connecting to a resource as well as the fact that there is a real human interacting with the access tool, albeit in a remote location.

The remote attacker may be detected using a number of methods, the results of which are collectable for further reporting purposes after detection.

(1) When a user is local, there is no cost to sample their mouse interactions as quickly as possible. Updates may come in at 60 Hz with little to no variance for a local user. When a user is remote, however, every update involves network traffic, which is constrained by bandwidth. Many remote control technologies “batch up” mouse communication, or skip messages entirely. An update frequency as low as 2 to 10 Hz may be detected. Furthermore, even when update frequencies are not limited, network jitter is much higher than local USB jitter. Thus, the time variance of events occurring in the browser may be much higher. It is noted that the method of detecting such variances requires processing the fact that mouse events are delivered to the browser somewhat lazily, or “asynchronously” (mouse events may, for example, be the measurement agent, but not necessarily, since remote control may work over Citrix or pure RDP connections as well). It is further important to differentiate network-inserted lag from browser-inserted lag, a differential which may be processed by looking at longer windows of mouse activity.

(2) There are various browser differentials that are exposed through remote control RDP, for example, for efficiency reasons, disables font smoothing in Internet Explorer (this may generally be described as “Detection of graphical optimizations triggered for efficient compression of remote desktop data). Since different images are generated for the remote user, the existence of the remote user may be imputed based on particularly detectable differences. Also it takes a non-negligible amount of CPU to compress and send desktop data with high frequency, so altering a screen element invisibly and updating it quickly may cause other processes to slow down more than usual. The detection and compilation of known differentials in imaging leads to a detection and conclusion of remote control activity. Thus, although a human rather than a bot is interacting with the host, differences other than non-humanlike behavior (e.g., imaging) act as a sign of compromising activity.

(3) Ultimately, interactive latency is a detectable signal, and a sufficiently distant user is physically unable to react as fast as a local user to changing user interface elements. Thus, by comparing a baseline interactivity rate from the legitimate user with a number of interactive tests (for example, time between demanding a screen repainting scroll, and moving the mouse to any location on the resulting page), a substantially high confidence warning signal (or remote control activity) is generated.

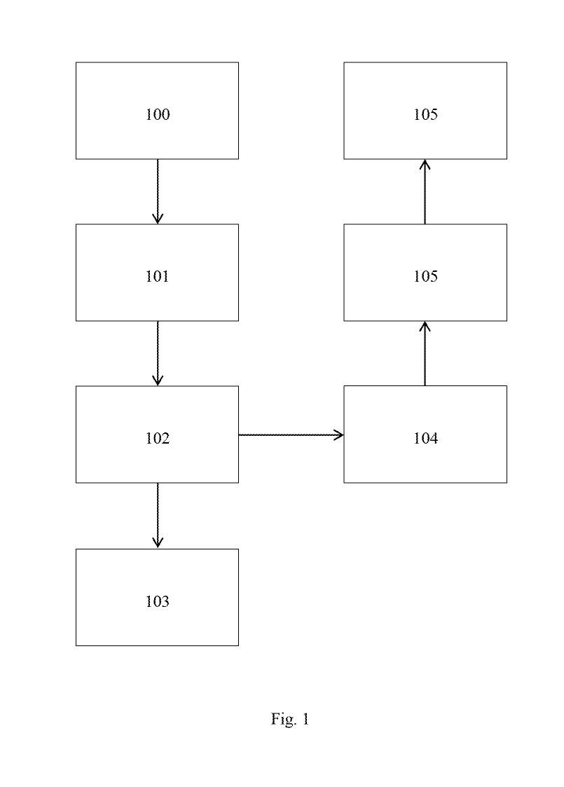

FIG. 1 provides one example of how the present invention may be deployed in a typical webpage scenario. First, a code snippet containing a unique identifier is inserted into the webpage 100. A user (local real user or remote attacker) then requests the web page containing the code snippet 101. The web page containing the code snippet is loaded by the user 102. And as the user continues browsing normally 103, data regarding the user's interaction with the web page is sent to the analysis server 104, where the analysis server further analyzes the user data qualitatively 105.

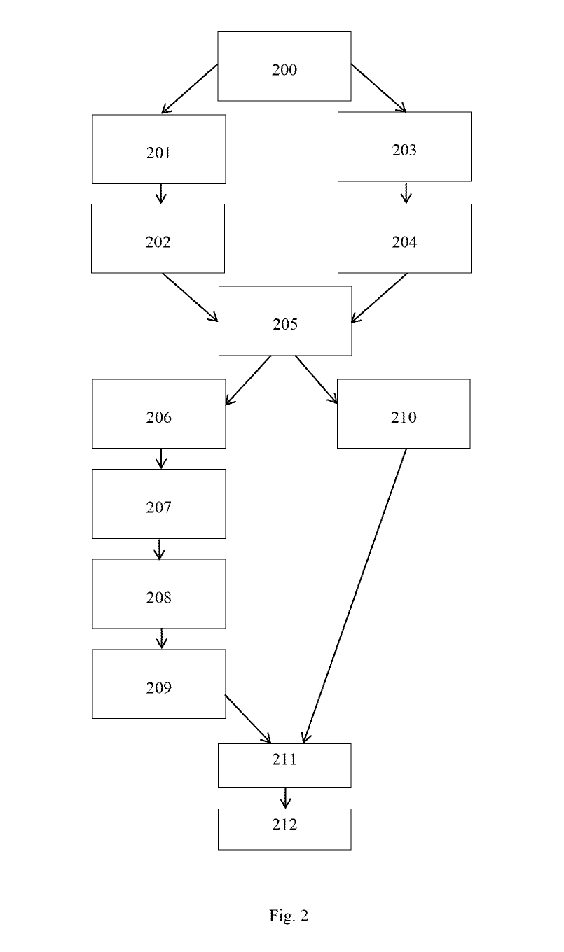

FIG. 2 provides an example application of the repeatable process employed by the present invention to analyze internet traffic. The illustrated process is comprised of the following steps: Declare or collect customer (i.e. client) identifier, peer (i.e. who the customer would like to test against, e.g., publisher, advertisement location, secondary exchange, etc.) identifier, and transaction (i.e. the particular advertisement view) identifier 200; Load Loader GS 201 from analysis server; Script load of Signal Flare GIF 202 from analysis server; load Signal Flare GIF 203 from analysis server; load human monitor (pagespeed.js) 204 from analysis server; Report load succeeded, under state “init” with all available metrics to analysis server 205; If remote control data is detected 206, immediately issue a second report (state “first”) 207, wait six (6) seconds 208, and issue a final report (state “statecheck”) 209; If no remote control data is detected 210, steps 207, 208, and 209 do not occur; Perform a qualitative analysis of available metrics and reports, if any 211; and Report a qualitative score for the Customer ID (session) 212.

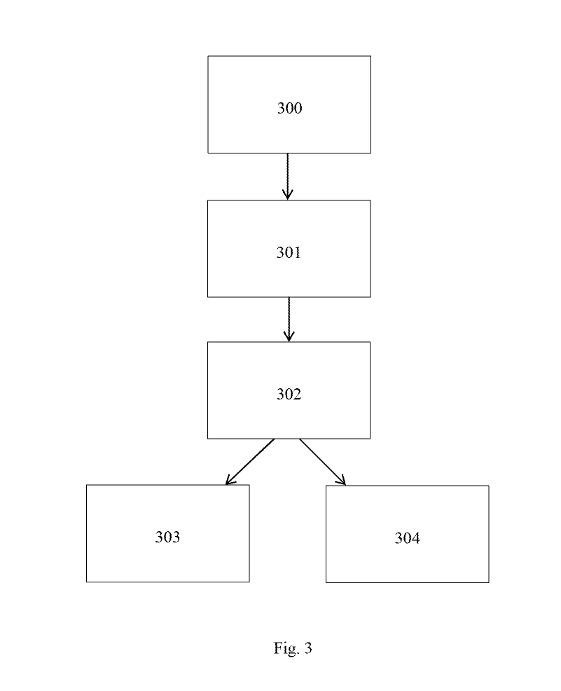

The process described above and illustrated by FIG. 2 is one example of the more general process employed and claimed by the present invention. Specifically, this broader process, shown in FIG. 3, occurs as follows: First, customer, peer, and transaction identifiers are collected 300; Next, these identifiers are embedded in an active probe, where the active probe (1) retrieves extra state from the client execution environment and (2) streams data back over multiple channels 301; Third, these actively probed characteristics are measured against known remote control patterns (i.e. remote control characteristics) 302. The two main classes of characteristics probed and analyzed are (1) mouse activity, particularly as it relates to coalescing of mouse movements, (2) impact on CPU and network bandwidth, and (3) quantization of time for particular events to occur. The performed analysis measures the degree/amount of remote control as well as the degree/amount of time human interaction. Finally, reports are issued (1) to the customer/client, reporting on the remote control percentage 303, according to the dimensions given in the peer identifier, and (2) to the server for further analysis and extra characteristics for more remote control pattern generation 304.

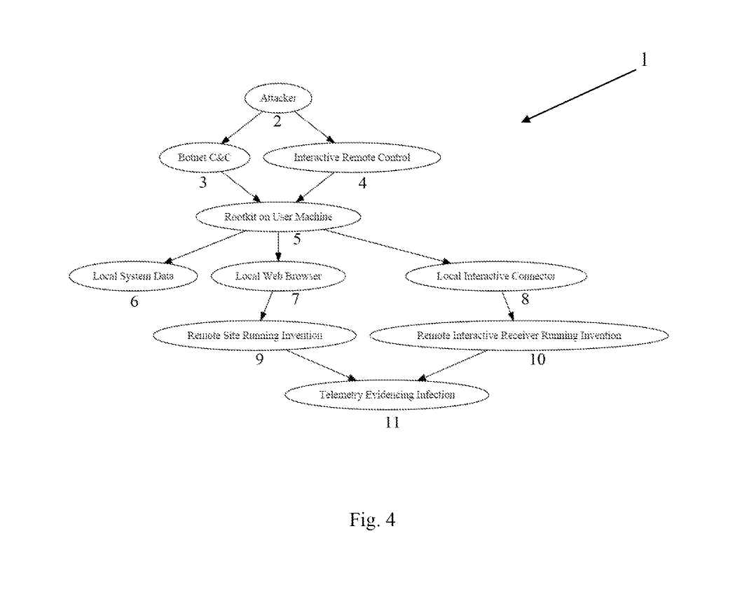

FIG. 4 illustrates an example of the overall process of fraud detection, particularly how the detection of bots and detection of remote control is intertwined within the overall detection system. An attacker 2 may be qualified as a bot or as a remote control user; thus, user data is collected regarding automated activity 3 and interactive remote control activity 4. This information then flows to a rootkit on the user machine 5. The rootkit 5 sends the information forward, organizing it into local system data 6, local web browser data 7, and local interactive connector data 8. The local web browser data 7 is directed to a remote site running the processing method of the present invention 9, while the local interactive connector data 8 is directed to a remote interactive receiver running the processing method of the present invention 10. Once the data is processed, a report is compiled (or a signal is released) detailing the state of potential infection 11.

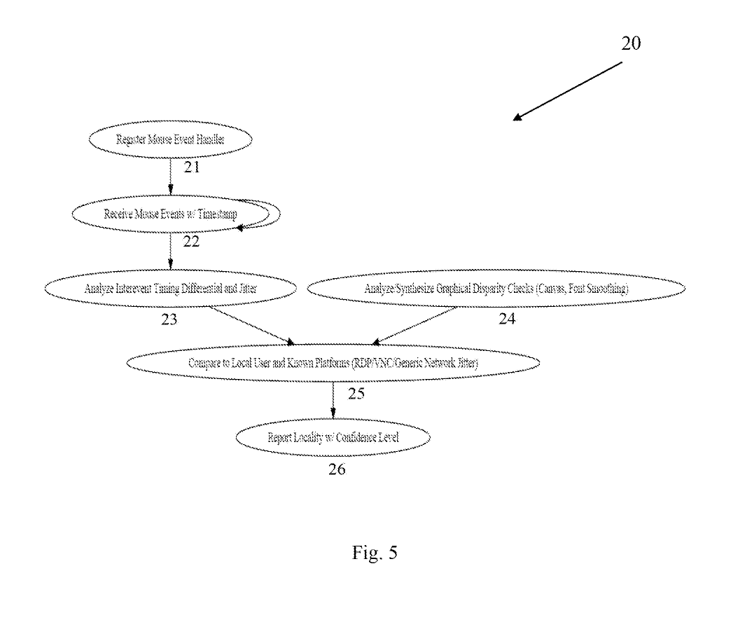

FIG. 5 exemplifies a process of compiling various remote control data into a report. This particular figure is an example of the compilation of inter-event and jitter data and graphical optimization metrics. Mouse events may be registered by registering a mouse event handler 21. Once a handler is installed, the system may receive mouse events with a timestamp 22. The receiving step 22 occurs again and again in cyclical fashion, compiling various packets of data. These packets of data are then analyzed 23 using the processes described herein. Packets of other data about graphical optimizations, e.g., graphical disparity data 24, arriving from a separate node, are also analyzed using the methods described herein. Analysis comprises sorting and referencing (i.e. comparing) the data, or packets of data, against known patterns and characteristics for remote control activity 25. After comparison and analysis, the results may be reported with a particular and quantifiable confidence level 26.

### EXAMPLE 1

The following example describes an example process for recording the difference between TCP acknowledgement and application acknowledgement as a reliable measure of the true triangulatable location of the remote controlling endpoint. If, e.g., the local user OS replies in 100 ms and the remote control application replies in 900 ms, the data collected and imputing such information implies the actual client hardware is 800 ms further away than the location of the compromised machine. For full triangulation, the best methodology is to have the actual client not route through the proxy; this may be made possible by using Flash sockets. In such a case, the real IP may be detected, and thus the attacker may be located independently of IP geo-databases, by connecting to multiple IPs around the globe and testing latency. The timing data may be collected via the same methods as described in U.S. patent application Ser. No. 14/057,730.

### EXAMPLE 2

The following example describes an example process for altering a screen element invisibly and updating it quickly in order to cause other processes to slow down more than usual, and how the latency created is detected or recorded. Interactive remote control software monitors for paint events, which are defined as messages that inform a machine of desktop update events with regard to particular regions of a screen. The region doesn't actually have to contain any significantly different pixels for the paint event to be noted. The remote controller receives the paint event just the same and must thus analyze, compress, and transmit the update regardless, consuming CPU and bandwidth. CPU consumption may be detected by running a 100% CPU operation and seeing how long it takes with pixel manipulation and without the pixel manipulation. Network consumption detection operates similarly but instead looks at rate limiting and jitter to detect that something is sending the updated pixels elsewhere. The latency is recorded in a manner similar to the processes disclosed in U.S. application Ser. No. 14/057,730.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A method for detecting and reporting on fraudulent remote control activity, comprising:
employing a means for detecting user information to obtain a metric, measuring a differential based on pattern characteristics for local users and pattern characteristics for remote control agents, transmitting, via asynchronous HTTP posts, said user information to a server, wherein said server records a finding based on said user information and said differential, and repeating said detecting, measuring, and transmitting, thus compiling a report on local versus remote control agent activity based on a qualitative evaluation of metrics obtained.

2. The method of claim 1, wherein said means for detecting further comprise: inserting a code snippet into a page HTML code before a page is sent to a user's browser and sending said page to a user's browser, wherein said code snippet causes data collection of user information once a user has loaded the page.

3. The method of claim 2, wherein said user information further comprises graphical optimization data triggered for efficient compression of transmitted data.

4. The method of claim 2, wherein said user information further comprises update frequency data.

5. The method of claim 2, wherein said code snippet is injected as an active scripting technology.

6. The method of claim 2, wherein said code snippet is injected either as JavaScript or as Flash.

7. The method of claim 2, wherein said user information further comprises network jitter data.

8. The method of claim 2, wherein said report further comprises a location of a remote attacker, said location being determined via a triangulation of data comprising at least 3 timing differentials.

9. The method of claim 2, further comprising: registering a handler and a listener for a given browser event, wherein said handler receives user information associated with said browser event and said listener enables recovery of otherwise unidentifiable data.

10. The method of claim 2, wherein said report is made available via: a password protected interactive HTML dashboard, an exportable spreadsheet document, and a subscription based email or PDF report.

11. The method of claim 2, wherein said report is generated within fifty milliseconds (50 ms) of a collection of a metric.

12. The method of claim 2, wherein said data collection, comparing, and report are implemented via batch processing.

13. The method of claim 2, wherein said data collection, comparing, and report are implemented via stream processing.

14. The method of claim 2, wherein said report further comprises a proxy detection report.

15. The method of claim 4, further comprising a repeating test for an amplification of small timing differentials.

16. A computer system for remote control detection, comprising:
a first stage of performance metric collection, comprising either sending a page containing a pre-inserted code snippet for recording of particular user information, at page load and after page load, or passively monitoring otherwise normal user behavior, thereinafter transmitting said performance metric to a first server,
a second stage of evaluation of said performance metric within said first server,
comprising comparing said performance metric against control groups comprising a growing plurality of pattern characteristics for human activity and a growing plurality of pattern characteristics for remote control activity, thus creating a user data unit, thereinafter transmitting, via an asynchronous HTTP post, said user data unit to a second server,
and a third stage of reporting within said second server, comprising recording a finding based on said user data unit,
wherein said stages are repeated, thus compiling a report on local user versus remote user activity based on performance metrics collected.

17. The system of claim 16, wherein said performance metrics comprise update frequency data and quantization of time data.

18. The system of claim 16, wherein said performance metrics comprise differential data with regard to coalescing mouse and keyboard events.

19. The system of claim 16, wherein said performance metrics comprise differential data with regard to an impact on CPU and network bandwidth.

20. The system of claim 16, wherein said performance metrics comprise differential data with regard to a graphical hardware configuration.
